(19) United States
(12) Patent Application Publication
(10) Pub. No.: US 2003/0047416 A1
(43) Pub. Date: Mar. 13, 2003

(54) Positioning apparatus for work carriers arranged on rails

(76) Inventors: Gunther Stephan Zimmer, Rheinau (DE); Martin Johannes Zimmer, Rheinau (DE)

Correspondence Address: CHARLES E. BAXLEY, ESQUIRE, Hart, Baxley, Daniels & Holton, Fifth Floor, 59 John Street, New York, NY, 10038, US

(21) Appl. No.: 10/238,488

(22) Filed: Sep. 9, 2002

(30) Foreign Application Priority Data
Sep. 12, 2001 (WO) PCT/EP02/00222

(51) Int. Cl. B27C 5/06

(52) U.S. Cl. 198/339.1

(57) ABSTRACT

A positioning apparatus that includes at least two rails, at least two work carriers, and a drive unit. The at least two rails (1) are arranged next to one another and have longitudinal directions. The at least two work carriers (2.1-2.n) are arranged on each rail (1) in such a way as to be traversable one behind the other in the longitudinal direction of the rail (1) and are able to be fixed independently of one another in selectable positions. The work carriers (2.1-2.n) traversable on the rails (1) are arranged next to one another so as to allow traverse drive of only one of the work carriers (2.1-2.n) on the rail (1) so as to form an independently driven work carrier that carries along at least one non-independently driven work carrier (2.2-2.n). The drive unit (5, 15) is provided on the rail (1) and/or on the driven work carrier (2.1).

### BACKGROUND OF THE INVENTION

1. [Technical field] Field of the Invention

The present invention relates to a positioning apparatus for work carriers arranged on two or more rails arranged next to one another, two or more work carriers being arranged on each rail in such a way as to be traversable one behind the other in [the] a longitudinal direction of [said] the rail and being able to be fixed independently of one another in selectable positions and also being able to be activated accordingly for this purpose. More particularly, the present invention relates to [Said] work carriers [serve] serving to accommodate workpieces, in particular plate-shaped workpieces, on which machining operations or assembly operations are carried out at one or more machining stations[. This], and mainly [involves] accommodating relatively large plate-shaped workpieces on a plurality of such work carriers, with the work carriers being positioned in such a way that they do not get in the way and are not damaged during [the] machining and assembly operations[. On], and on the one hand, [this is] being achieved by the work carriers arranged one behind the other in a row on [the] a respective rail being traversed relative to one another[;], and on the other hand, the rails carrying the work carriers can be moved relative to one another in their transverse direction.

2. [Prior art] Description of the Prior Art

A positioning apparatus [of the type explained above has been disclosed] is taught by DE 44 44 339 C1. The work carriers of [the] this machine tool [described in this document] are designed as “suction clamps”[,] on which [the] workpieces are fixed by means of a vacuum[. So] so that the work carriers, for adaptation to workpieces having different formats, can be traversed into [the] an appropriate position in each case, [they] and can be coupled to an external drive. To this end, a traversable extension arm is arranged [in the known machine] above [the] a machining-space or clamping plane which is formed by [the] top sides of the work carriers[, this]. This extension arm [carrying] carries a driving device which can be brought into engagement with each of the work carriers.

Other fully automatic positioning apparatuses are also known in which [the] individual work carriers can be positioned by means of a positioning axis at [the] a selected location on [the] a relevant rail. In this case, each work carrier is provided with an independent drive and an independent control system. Although rapid, flexible positioning of each work carrier is thus possible, the mechanical and control outlay for such positioning apparatuses is very considerable.

### [DESCRIPTION OF THE INVENTION] SUMMARY OF THE INVENTION

[Starting from the aforesaid prior art, the] The present invention is based on the fact that[,] in order to position [the] individual work carriers on each of the rails, it is not necessary to provide each of the work carriers with an independent drive. To this end, it is also not necessary to be able to couple each of the work carriers to an external drive. This is because the work carriers arranged together in a row one after the other on a rail cannot deviate from one another during [the] traverse along the rail, for which reason it is possible to traverse a work carrier by it being carried along by another displaced work carrier, provision having to be made for it to be possible to carry this out in both traverse directions on [the] a relevant rail.

The object of the present invention is therefore to provide a positioning apparatus [of the type mentioned at the beginning] in which [the] drive required for the traverse of the work carriers on the rails is considerably simplified.

To achieve this object in such a positioning apparatus, the work carriers traversable on the rails have coupling devices, with which they can be coupled in each case to an adjacent work carrier on [the] an associated rail. For [the] traverse drive [in each case] of only one of the work carriers on one of the rails, a drive unit is provided on this rail and/or on this one work carrier, and the further work carriers on this rail are non-independently driven work carriers, which if need be are carried along by the driven work carrier or by a work carrier moved by the latter for [the] traverse into a new position.

For the present invention, it is essential that the work carriers can be coupled to one another so that it is not only possible to traverse the work carriers as a push unit when they bear against one another but it is also possible to position them in the opposite traverse direction by virtue of the fact that they can be coupled to one another to form a work carrier train. In a special embodiment, the force of gravity may be used for coupling the work carriers.

### [BRIEF DESCRIPTION OF THE DRAWINGS] BRIEF DESCRIPTION OF THE DRAWING

In the [drawing, in detail] drawing:

FIG. 1 [shows the] is a perspective view of a single rail of a positioning apparatus with four work carriers arranged thereon in a reference or initial position[,];

FIG. 2 [shows] is a perspective view which corresponds to FIG. 1 and in which [the] individual work carriers in each case assume defined positions[,];

FIG. 3 [shows another] is a perspective view of the arrangement according to FIG. 1 in another position of the work carriers[,];

FIG. 4 [shows] is an enlarged perspective representation of the coupling device effective between two work carriers[,];

FIG. 5 [shows] is a longitudinal section through two adjacent work carriers in [the] a region of [the] a disengaged coupling device[,];

FIG. 6 [shows] is a longitudinal section corresponding to FIG. 5 but with engaged coupling devices of the adjacent work carriers[,];

FIG. 7 [shows] is a perspective view of a work carrier on a rail which has a drive belt integrated therein[,];

FIG. 8 [shows] is a perspective view of a work carrier on a rail which has an independent drive[,];

FIG. 9 [shows the] is a plan view of a complete positioning apparatus with a plurality of rails lying next to one another and work carriers arranged thereon[,]; and

FIG. 10 [shows a further] is a plan view of a complete positioning apparatus [in] of another embodiment.

### [BEST WAY OF IMPLEMENTING THE INVENTION] DETAILED DESCRIPTION OF THE PREFERRED EMBODIMENTS

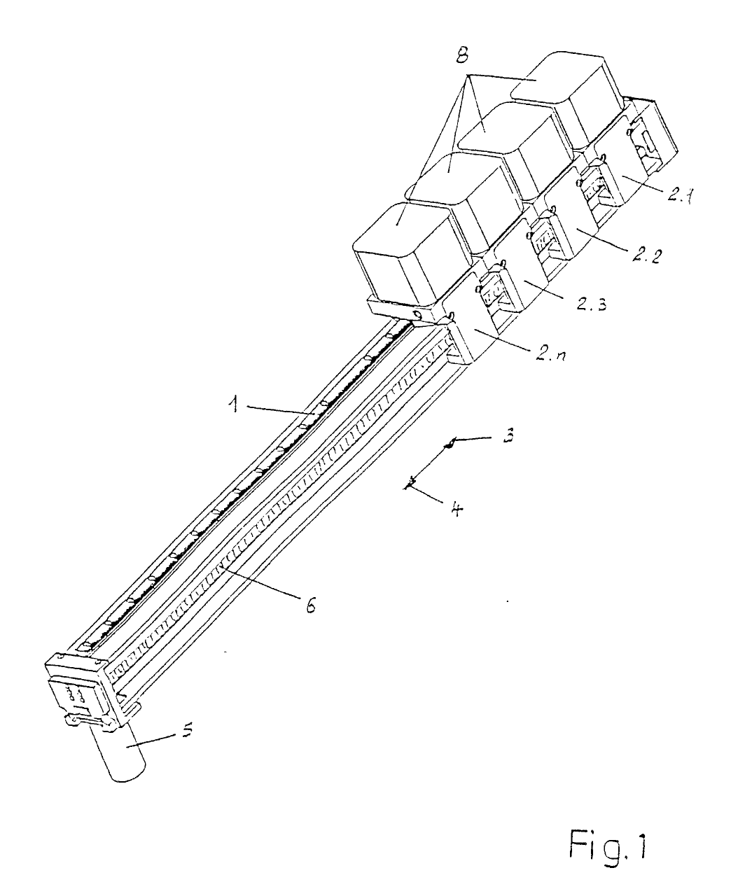

The positioning apparatus of the present invention, shown partially in FIGS. 1 to 3, is preferably of modular construction and has rails, of which only one rail 1 is shown [here], on which work carriers 2.1, 2.2, 2.3, 2.n are mounted so as to be displaceable or traversable in [the] arrow directions 3 and 4. A motor 5 is arranged under the rail 1 [is designated by 5] and is part of a drive unit 5, 15. In the present embodiment, the motor 5 drives a toothed belt 6, to which one of the work carriers 2.1, 2.2, 2.3, 2.n, in particular the work carrier 2.1, can be mechanically connected for the purpose of [the traverse of] traversing the work carriers 2.2, 2.3, 2.n to individual positions 7, 8 in conformity with [the] a control program. In the appropriate position 7, 8 [in each case], a workpiece is mounted on the work carriers 2.1, 2.2, 2.3, 2.n. The work carriers 2.1-2.n can be fixed to the rail 1 in the [approached] appropriate positions 7, 8.

Instead of the motor 5 arranged in a fixed position on the rail 1, a suitable independent drive unit may be fitted into one of the work carriers 2.1, 2.2, 2.3, 2.n, in particular into the work carrier 2.1. For this purpose, the rail 1 can be provided with a toothed rack (not shown in any more detail) for the engagement of a drive pinion of the drive unit on the work carrier 2.1.

FIG. 1 shows the work carriers 2.1, 2.2, 2.3, 2.n provided on the rail 1 in [the] an initial or “reference” position.

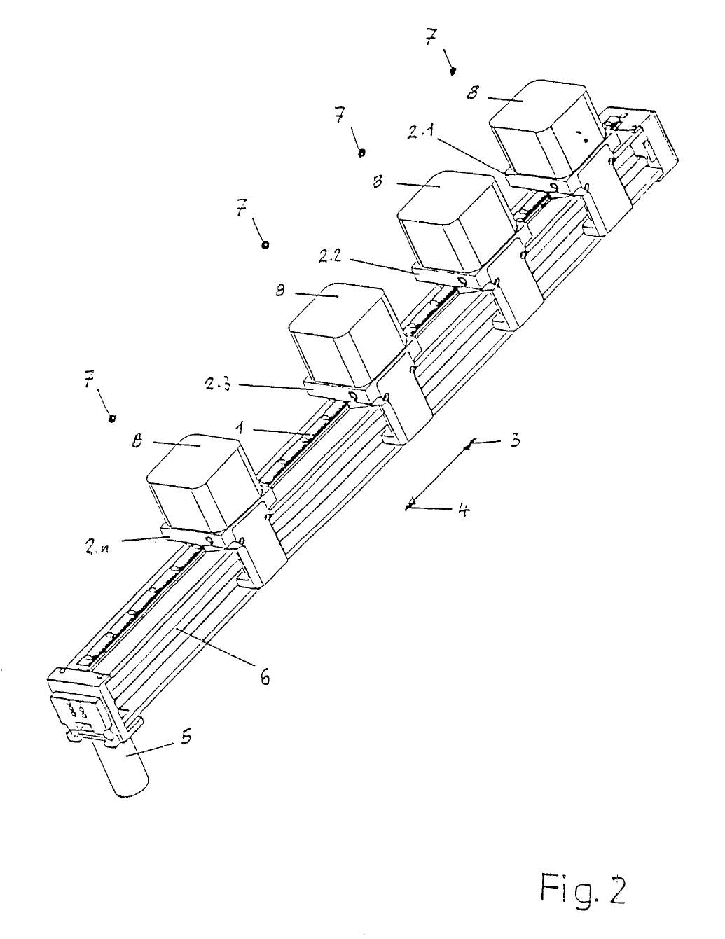

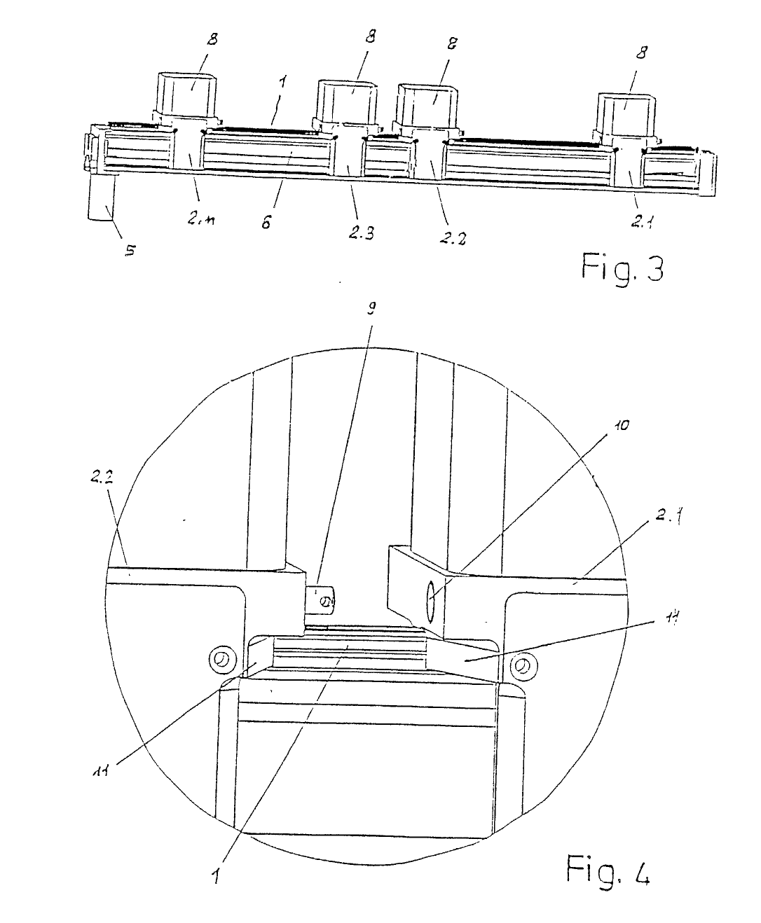

FIG. 2 shows the work carriers 2.1 to 2.n in their respective defined position 7, 8, which is predetermined by the control program of the positioning apparatus and in which the work carriers 2.1-2.n can be fixed.

[FIGS. 3 and 4 show] FIG. 4 shows the releasable, and in particular remotely controllable, coupling devices 9, 10 between the individual work carriers 2.1-2.n. These coupling devices 9, 10 include a coupling pin 9 in [the] one work carrier 2.1-2.n-1 and a corresponding coupling housing 10 in [the] a respectively adjacent work carrier 2.2-2.n. There are also chip deflectors 11, which are arranged on the individual work carriers 2.1-2.n on both sides of the rail 1 and adjacent to the latter. In a preferred embodiment, the individual work carriers 2.1-2.n are of an L-shaped design.

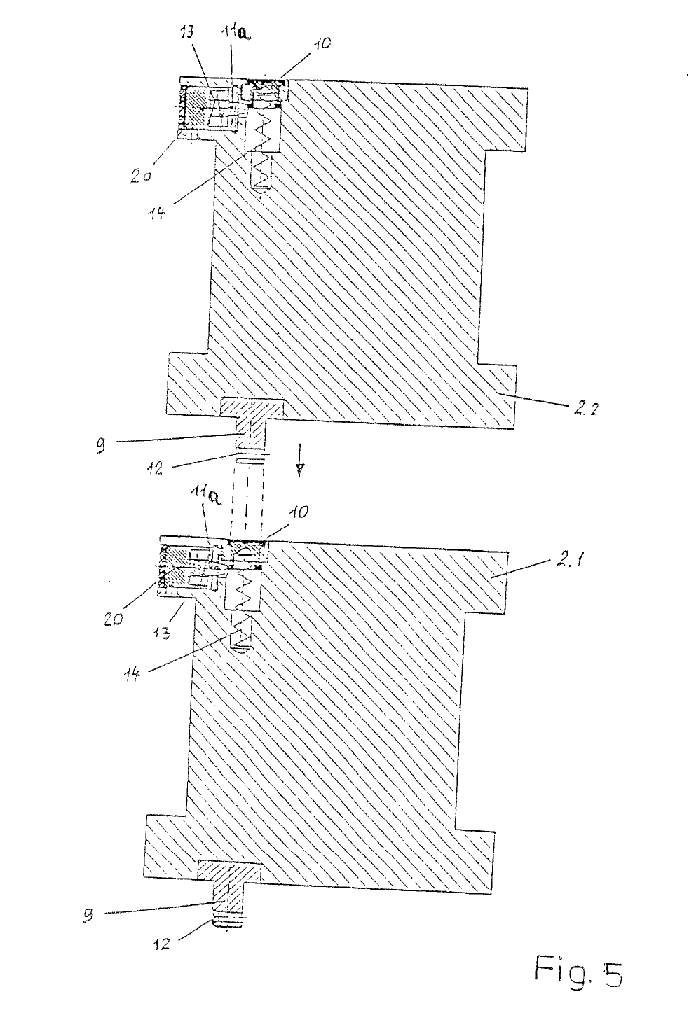

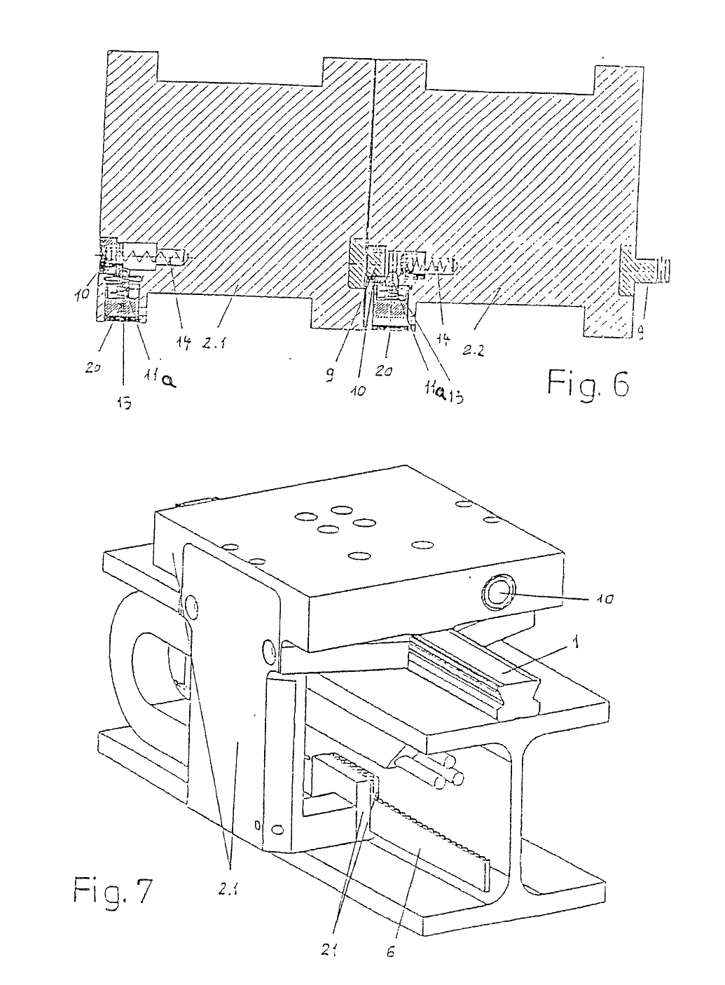

The coupling devices 9, 10 provided on the work carriers 2.1-2.n can be seen in more detail from [figs] FIGS. 5 and 6. Here, too, the respective coupling pin 9 arranged on [the] one side of the relevant work carrier and the coupling housing 10 which corresponds to [said] the coupling pin 9 and is arranged on the opposite side of the adjacent work carrier can be seen.

The coupling devices 9, 10 are expediently designed as “latching couplings”. As can be seen from [the illustrations] FIGS. 5 and 6, the coupling housing 10 is provided with a remotely controllable latching pin 11a, which in the coupled state, perpendicularly to [the] axis 20 of the latching pin 11a, engages in a releasable frictional manner in a latching notch 12 on the coupling pin 9. In this case, the latching pin 11a is mounted so as to be controllable, in particular hydropneumatically, against [the] effect of [the] force of a spring 13. In addition, provision is made for the coupling pin 9 to be capable of being inserted into the coupling housing 10 against [the] effect of [the] force of a spring 14.

FIG. 7 shows the rail 1 with the drive arranged so as to run on it, namely [a] the toothed belt 6. The work carrier 2.1 is driven via [said] the drive and is provided with a remotely controllable clamping coupling 21 for the purpose of coupling to the toothed belt 6. The clamping coupling 21 is expediently remotely controlled in a hydropneumatic manner.

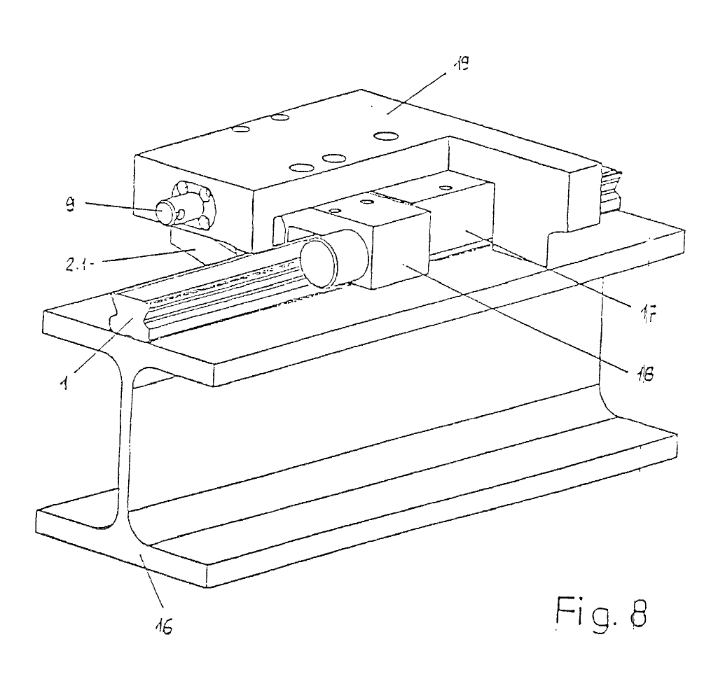

FIG. 8 shows one of the work carriers 2.1-2.n on [a] the rail 1 which is arranged on a rail-like beam 16. A guide carriage 17 is traversable along the rail 1[, this]. The guide carriage 17 [having] has a controllable clamping element 18 which serves to releasably fix the work carrier 2.1-2.n to the rail 1 in a frictional manner. The [tool] work carrier 2.1-2.n has a base plate 19, on which the workpiece to be machined can be releasably arranged in a frictional manner. [Here, the] The coupling pin 9 of the work carrier 2.1 to 2.n is arranged on the base plate 19.

The coupling devices 9, 10 of the work carriers 2.1-2.n may also be designed as magnetic couplings or adhesive couplings, as with the use of vacuum.

For certain applications[,] of the positioning apparatus[,] provision may also be made for the coupling devices 9, 10 to be dispensed with, which requires the rail 1 to be arranged at an angle or vertically. In this case, [the] tensile forces otherwise required between the traversable work carriers are replaced by the force of gravity, and therefore the driven work carrier 2.1 in this variant must be arranged [right] at the bottom. The further non-independently driven work carriers 2.2-2.n are traversed or lifted upward or lowered via the driven work carrier 2.1, in which case, with the start of the lowering, first of all the work carrier arranged right at the top, in the position assigned to it, is secured to the rail 1 by activating the fixing device, for example the clamping element 18, and the further work carriers, during the further lowering, are subsequently positioned on the rail 1 in the same way.

In principle, the rail 1 may have any desired cross sections provided that this should be advantageous for guiding the work carriers 2.1-2.n. In practical use, two or more rails 1 arranged parallel to one another and traversable relative to one another in [the] a transverse direction are provided, and this is dealt with in more detail below.

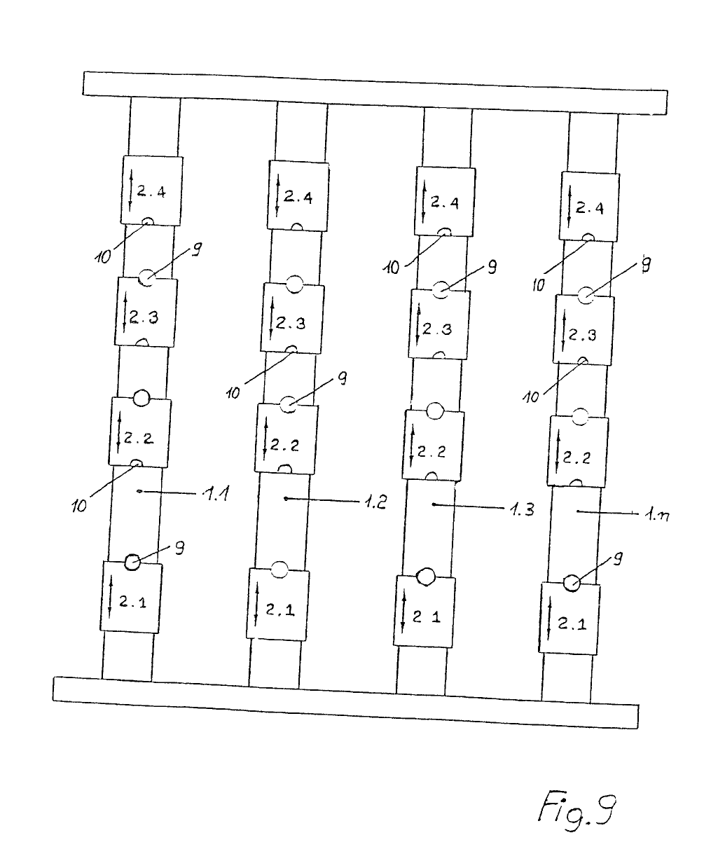

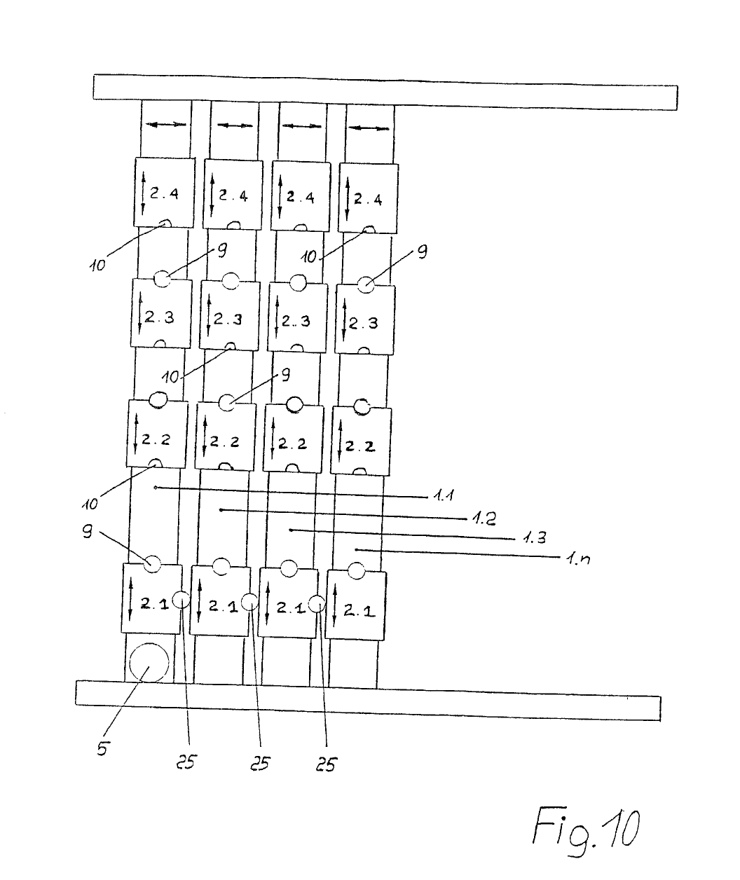

The positioning apparatus, which is provided with a plurality of the rails 1 described and the work carriers 2.1-2.n traversable thereon, is preferably used in machine tools with which plate-shaped workpieces of wood or wood substitutes are machined. In this case, the work carriers are designed as “suction clamps” which form with their top sides [the] a clamping plane for the plate-shaped workpieces. FIGS. 9 and 10 show [the] a plan view of such a clamping plane.

For clamping plate-shaped workpieces having larger formats, a plurality or multiplicity of work carriers 2.1-2.n are required, which are arranged on a plurality of rails 1.1-1.n arranged in parallel next to one another. The rails 1.1-1.n are traversable relative to one another in their transverse direction, whereby each of the work carriers 2.1-2.n can be positioned inside a region of the clamping plane for [the] relevant workpieces.

In [the] an exemplary embodiment according to [FIG.] FIG. 9, the work carriers 2.1 on each of the rails 1.1-1.n are the driven work carriers and the remaining, non-independently driven work carriers 2.2-2.n can be positioned [here] on the relevant rail 1.1 to 1.n in the way as described above.

FIG. 10 shows a positioning apparatus which is similar to that of [FIG.] FIG. 9 but is further simplified with regard to the drive for traversing the work carriers 2.1-2.n. Here, of the total of sixteen work carriers 2.1-2.4 present, only a single work carrier is provided with a drive, namely the work carrier 2.1 on the rail 1.1. Via the motor 5, this work carrier 2.1 is traversed along the rail 1.1 in the manner described above. At the same time, the rails 1.1-1.n parallel to one another can be brought transversely to their longitudinal extent into a position adjacent to one another, which is illustrated by [FIG.] FIG. 10. In this case, via couplings 25, which, with regard to the rails 1.1-1.n, are located on a longitudinal side of the work carriers 2.1, which are in an identical position on the rails 1.1-1.n, [come be] are connected to one another, whereby a synchronous traverse of all the work carriers 2.1, in a rail-overlapping [manner as it were], can be carried out. Irrespective of this, the work carriers 2.1-2.n on each rail 1.1-1.n are provided with the coupling devices 9, 10 explained above, for which reason each of the further, non-independently driven tool carriers 2.2-2.n can be positioned via [the] traverse of [the] a respective [tool] work carrier 2.1 on each rail 1.1-1.n in the manner described above. This is because, as in the exemplary embodiments described above, each of the work carriers 2.1-2.n can also be fixed by itself independently of the others on the relevant rail 1.1 to 1.n, for which purpose a fixing arrangement independent of the positioning drive is provided.

1. A positioning apparatus, comprising:
a) at least two rails (1) arranged next to one another and having lonitudinal directions and sides;
at least two work carriers (2.1-2.n) being arranged on each rail (1) in such a way as to be traversable one behing the other in said longitudinal direction of said rail (1) and being able to be fixed independently of one another in selectable positions; said work carriers (2.1-2.n) traversable on said rails (1) are arranged next to one another so as to allow traverse drive of only one of said woek carriers (2.1-2.n) on at least one rail (1) so as to form an independently driven work carrier that carries along at least one non-independently driven work carrier (2.2-2.n); and
c) a drive unit (5, 15) proviede on at least one of said rail (1) and said independently driven work carrier (2.1).

2. The positioning apparatus as claimed in claim 14, wherein said coupling devices (9, 10) on said work carriers (2.1-2.n) are designed as latching couplings.

3. The positioning apparatus as claimed in claim 2, wherein said latching couplings (9, 10) consist of a coupling pin (9) arranged on one work carrier (2.1-2.n) and a coupling housing (10) arranged on a second work carrier (2.2-2.n) and is coaxially opposite said coupling pin (9) and has a remotely controllable latching pin (11), which in a coupling position, engages in a positive-locking manner in a latching notch (12) on said coupling pin (9) accommodated in said coupling housing (10).

4. The positioning apparatus as claimed in claim 3, wherein said latching pin (11a) is displaccable in a hydropneumatically controllable manner against force of a first spring (13).

5. The positioning apparatus as claimed in claim 4, wherein said coupling pin (9) is inserted into said coupling housing (10) against force of a second spring (14) which is arranged in said coupling housing (10).

6. The positioning apparatus as claimed in claim 5, wherein said work carrier (2.1) arranged at a front end of a row of work carriers (2.1-2.n) on said rail (1) is said independently driven work carrier.

7. The positioning apparatus as claimed in claim 6, wherein said drive unit (5, 15) of said independently driven work carrier (2.1) has a toothed belt (15) running parallel to said rail (1) and driven by means of a motor (5).

8. The positioning apparatus as claimed in claim 7, wherein said driven work carrier (2.1) and said toothed belt (15) are mechanically connected to one another by means of a coupling (21).

9. The positioning apparatus as claimed in claim 8, wherein said coupling (21) is controllable.

10. The positioning apparatus as claimed in claim 9, wherein said work carriers (2.1-2.n) consist of a guide carriage (17) of L-shaped design guided on said rail (1), and a base plate (19) coupled to said guide carriage (17) for accommodating and arranging workpieces.

11. The positioning apparatus as claimed in claim 10, wherein said work carriers (2.2-2.n) are traversable in both push operation and pull operation via said independently driven work carrier (2.1); said coupling devices (9, 10) being disengaged during a push operation and being in engagement with one another during a pull operation.

12. The positioning apparatus as claimed in claim 11, wherein said independently driven work carrier (2.1) is arranged only on one of said rails (1); said independently driven work carrier (2.1), on at least one of its sides lying on said longitudinal sides of said rail (1.1), has a coupling (25) with which it is coupled to one of said non-independently driven work carriers (2.1-2.n) of a second rail (1.2) so as to form an indirectly driven work carrier (2.1), which is positioned adjacent said longitudinal side of said one of said rails (1); said indirectly driven work carrier (2.1) on said second rail (2.1) coupled to a work carrier (2.1) which is arranged on a third rail (1.3), which is positioned adjacent to said second rail (1.2), and repeated for any number of said rails.

13. The positioning apparatus as claimed in claim 1, wherein said work carriers (2.1-2.n) are positioned in both traverse directions in push operation using force of gravity, said respectively independently driven work carrier (2.1) is arranged at a bottom end of a row of said work carriers (2.1-2.n) located on said rail (1), and said work carriers (2.1-2.n) are not coupled to each other in said row, all when said rails (1) are arranged so as to be inclined or vertical.

14. The positioning apparatus as claimed in 1, wherein said work carriers (2.1-2.n) have coupling devices (9, 10), with which they are coupled to at least one adjacent work carrier (2.1-2.n) on an associated rail (1).

15. The positioning apparatus as claimed in claim 13, wherein said work carrier (2.1) arranged at a front end of a row of work carriers (2.1-2.n) on said rail (1) is said independently driven work carrier.

16. The positioning apparatus as claimed in claim 15, wherein said drive unit (5, 15) of said independently driven work carrier (2.1) has a toothed belt (15) running parallel of said rail (1) and driven by means of a motor (5).

17. The positioning apparatus as claimed in claim 16, wherein said driven work carrier (2.1) and said toothed belt (15) are mechanically connected to one another by means of a coupling (21).

18. The positioning apparatus as claimed in claim 17, wherein said coupling (21) is controllable.

19. The positioning apparatus as claimed in claim 18, wherein said work carriers (2.1-2.n) consist of a guide carriage (17) of L-shaped design guided on said rail (1), and a base plate (19) coupled to said guide carriage (17) for accommodating and arranging workpieces.

20. The positioning apparatus as claimed in claim 19, wherein said independently driven work carrier (2.1) is arranged only on one of said rails (1); said independently driven work carrier (2.1), on at least one of its sides lying on said longitudinal sides of said rail (1.1), has a coupling (25) with which it is coupled to one of said non-independently driven work carriers (2.1-2.n) of a second rail (1.2) so as to form an indirectly driven work carrier (2.1), which is positioned adjacent to said longitudinal side of said one of said rails (1); said indirectly driven work carrier (2.1) on said second rail (2.1) coupled to a work carrier (2.1) which is arranged on a third rail (1.3), which is positioned adjacent to said second rail (1.2), and repeated for any number of said rails.
